(19) United States
(12) Patent Application Publication
(10) Pub. No.: US 2019/0017281 A1
(43) Pub. Date: Jan. 17, 2019

(54) Aircraft Access / Safety Units

(71) Applicant: Martin H. Luna, Dallas, TX (US)

(72) Inventor: Martin H. Luna, Dallas, TX (US)

(21) Appl. No.: 15/649,291

(22) Filed: Jul. 13, 2017

(51) Int. Cl. E04G 1/36; B64F 5/40; E04G 5/04; E04G 1/24; E04G 5/10

(52) U.S. Cl. CPC E04G 1/36; B64F 5/40; E04G 3/243; E04G 1/24; E04G 5/10; E04G 5/04

(57) ABSTRACT

Disclosed is a device for enabling an aircraft maintenance operator to access the exterior body of the aircraft. The device is adapted to be releasingly anchored to the fuselage of the aircraft. The device comprises a platform disposed above and transversely with respect to the fuselage and a pair of legs straddling the fuselage wherein, the platform extends between the pair of legs. Each leg comprises a leading means for leading the operator to reach the platform from the ground therethrough.

The invention disclosed herein generally relates to devices and equipment employed for the safety of the aircraft maintenance personnel and more particularly to an aircraft body access device that enables an aircraft maintenance operator to safely access the fuselage from above.

Maintenance of aircraft is a comprehensive and continuous process. The whole aircraft needs to be inspected, maintained, and have the essential parts substituted to maintain the safety standards mandated by different aviation systems and engineering practices. Aircrafts are compulsorily maintained after a certain period of calendar time, or flight cycles. Also, some of the aircraft components have a specific life limit, and need to be substituted instantaneously upon maximum usage. Apart from these issues, the aircraft components that are due for replacement, and all the other accessory parts, need to be checked for complaints or faulty performance. Now, one of the major concerns in the aircraft maintenance is the ability of the technician to reach different parts of the aircraft, especially the fuselage which has a generally curved outer surface, which makes it difficult for the technician to clean and maintain the components positioned along the fuselage.

Currently, the technicians, when working externally on the aircraft, is subject to the sun beating down, subject to frost or snow accumulating on the aircraft skin which needs to be repaired, or rainfall. The technicians, working in these elements, has to use a ladder, and then scramble all over the skin of the airplane to make the required repairs or maintenance. Conventionally designed ladders or access means are used for this purpose, but such ladders or access means are not safe for the technician because the aircraft skin is often slick and the technician can slip and fall on the airplane surface, injuring themselves, or can fall off the aircraft, falling a long distance to the tarmac and causing certain injury or even death.

Further, access for technicians to the top or crown portions of an aircraft, especially if it's a large commercial aircraft, can prove to be a difficult scenario. The maintenance on aircraft when required must be done in a timely and safe manner. Hangar access is not always available, and often due to the sheer size of the aircraft, it requires that the maintenance to be done outdoors. The crown of an aircraft will frequently contain components that require service, and that means that someone must have access to the crown section. Further, the required service has to be done without damaging the delicate surface area of the aircraft. Service duties should also be performed in a safe and protective environment for the technicians involved. Occupational Safety and Health Standards (OSHA) based safety regulations have to be respected for the working technician's own personal welfare. This can create an untenable situation when working on an aircraft in an outdoor setting without the proper equipment.

Hence, there is a long felt but unresolved need for an aircraft body access device which resolves almost all of the above mentioned issues, especially when the technician is working on the upper surface of the fuselage when the aircraft is moved outside the hangar, where he/she needs to carry out maintenance activities under a shade from the sun, and without slipping off the surface off the fuselage.

### SUMMARY

An embodiment of the present invention comprises a device for enabling an aircraft maintenance operator to access the exterior body of an aircraft (also known as fuselage) for periodical maintenance purposes thereof and the like. The device comprises a substantially frame structure, which is adapted to be firmly anchored to the fuselage. The device comprises a pair of vertical legs and an elongate horizontal platform extending between top extremities of the pair of vertical legs. While the pair of legs straddles the sides of the fuselage, the platform is disposed above and across the fuselage.

Each leg two staircases, viz., bottom and top staircases, incorporated substantially therewithin. Notably, the direction of ascent (or descent) of the top and bottom staircases is perpendicular to each other. As viewed from front, the bottom staircases are parallel to each other, while the top staircases, with respect to the direction of the ascent thereof, are slanted inwardly. Each leg further comprises a landing area connecting the bottom and top staircases. Two openings are disposed on the platform wherein, each opening is connected to a top staircase. Each opening is intended to lead the operator therethrough onto the platform from the top staircase. A step assembly comprising a plurality of steps leads the operator from the platform onto the top of the fuselage. The platform further comprises a railing provided on all sides thereof.

The device further comprises a horizontal, rectangular bottom frame extending between the legs closer to the bottom extremities thereof. The bottom frame is located directly beneath the platform and is adapted to go beneath the fuselage. The bottom of the legs and the bottom frame are fitted with a plurality of dual caster wheels, which are adapted to carry more than the weight of the device. The dual caster wheels also help in adjusting the device, when the device is being anchored to the fuselage.

An anchoring means is employed for anchoring the device to the fuselage. The anchoring means comprises a pair of opposingly-disposed anchor assemblies extending between the platform and the bottom frame wherein, each anchor assembly is configured to engage a side of the fuselage. Notably, each anchor assembly is disposed between a side of the fuselage and the leg that is proximal thereto.

The anchor assembly comprises top and bottom oblique, rectangular anchor frames. Each of the top and bottom anchor frames comprises a solid, centrally-disposed anchor plate, which comprises two threaded holes. While the top anchor frame extends obliquely downwardly from the bottom of the platform, the bottom anchor frame extends obliquely upwardly from the top of the bottom frame. The anchor assembly further comprises a mid frame connecting the top and bottom anchor frames forming a substantially concave structure with respect to the side of the fuselage.

The anchor assembly further comprises a plurality of jackscrews, each of which is adapted to be threadably received within a threaded hole. Each jackscrew comprises a threaded rod, the proximal and distal extremities of which are disposed in operational communication with a drive wheel and a pressure pad. As the threaded rod is threadably received within the threaded hole, the rotation of the drive wheel causes the threaded rod to be advanced or retracted via the threaded hole. The pressure pad is secured to threaded rod by means of a ball-and-socket joint. By virtue of the rotation of the drive wheel, the pressure pad is intended to firmly engage the surface of fuselage by means of sheer pressure. Notably, the contour of the pressure pad matches that of the side of the fuselage so as to achieve a proper fit therebetween. The ball-and-socket joint is also instrumental in ensuring a proper engagement between the pressure pad and the side of the fuselage. Once all the jackscrews (on both the anchor assemblies) are engaged to the fuselage, the device is rendered anchored to the fuselage.

Other features and advantages will become apparent from the following description of the preferred embodiments, taken in conjunction with the accompanying drawings.

### BRIEF DESCRIPTION OF THE DRAWINGS

Various embodiments of the disclosed system and method are described herein with reference to the accompanying drawings, which form a part of this disclosure, wherein:

FIG. 1, according to an embodiment of the present invention, is an illustration of the aircraft body access device anchored to the fuselage of an aircraft.

FIG. 2, according to an embodiment of the present invention, is an illustration of a perspective view of the device.

FIG. 3, according to an embodiment of the present invention, is an illustration of a front view of the device.

FIG. 4, according to an embodiment of the present invention, is an illustration of a side view of the device.

FIG. 5, according to an embodiment of the present invention, is an illustration of a top view of the device.

FIGS. 6A and 6B, according to an embodiment of the present invention, are illustrations of the front and side views of the dual caster wheels.

FIG. 7, according to an embodiment of the present invention, is an illustration of a perspective view of the anchor assembly.

FIG. 8, according to an embodiment of the present invention, is an illustration of a jackscrew received within an anchor frame.

FIG. 9, according to an embodiment of the present invention, is an illustration of a perspective view of the usable section anchored to the fuselage of an aircraft.

FIG. 10, according to an embodiment of the present invention, is an illustration of a side view of the usable section anchored to the fuselage of an aircraft.

FIG. 11, according to an embodiment of the present invention, is an illustration of two devices anchored to the fuselage of an aircraft.

The various aspects of the present disclosure mentioned above are described in further detail with reference to the aforementioned figures and the following detailed description of exemplary embodiments.

### FIGURES—REFERENCE NUMERALS

10—Aircraft Body Access Device
12—Fuselage
14—Leg
16—Platform
17—Bottom Frame
18—Anchor Assembly
20—Step Assembly
22—Bottom Staircase
24—Top Staircase
26—Landing Area
30—Dual Caster Wheel
32—Railing
34—Doorframe
36—Opening
38T—Top Anchor Frame
38B—Bottom Anchor Frame
39—Anchor Plate
40—Mid Frame
42—Jackscrew
44—Threaded Rod
46—Pressure Pad
48—Drive Wheel
50—Ball-and-Socket Joint
52—Usable Section
54—Usable Platform Segment
56—Usable Bottom Frame Segment
58—Strap
60—Cable
62—Aircraft Maintenance Operator
64—Harness

### DETAILED DESCRIPTION

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

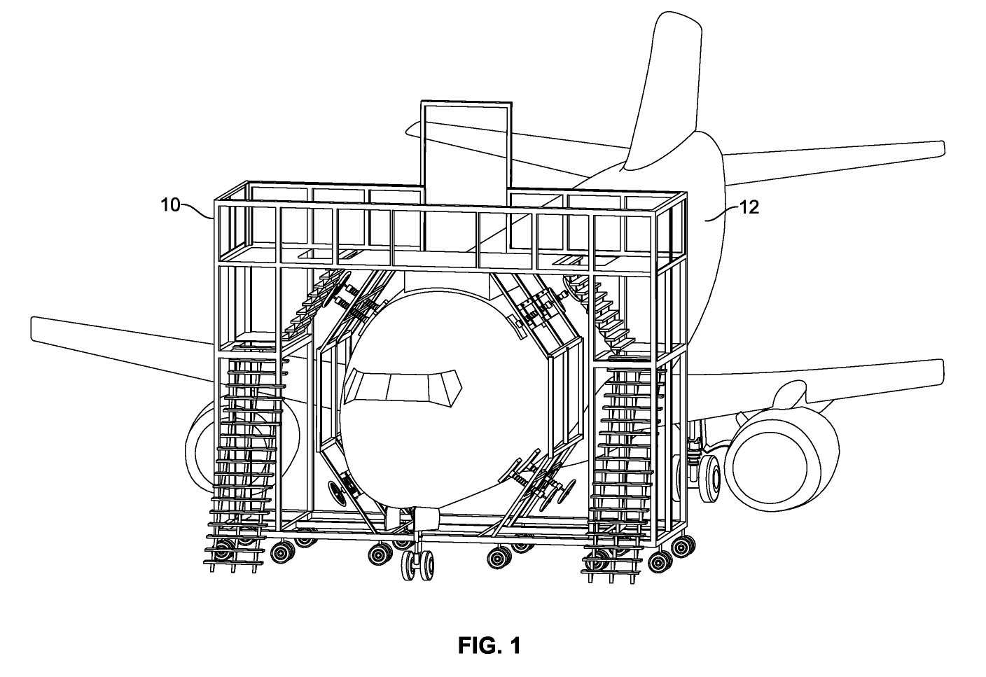

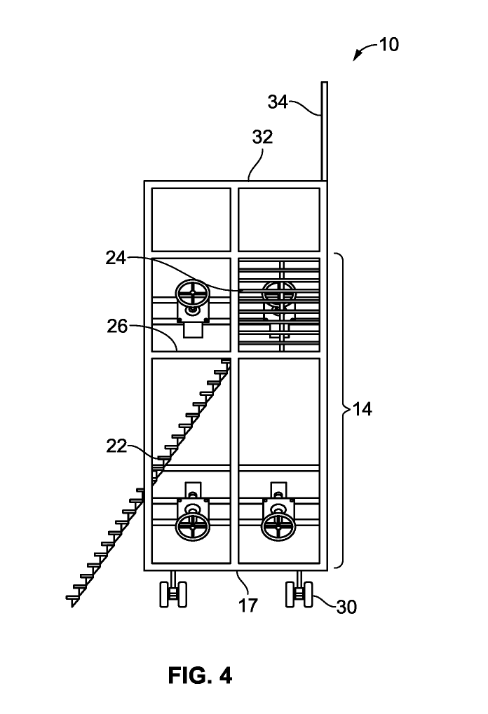

Embodiments of the present invention are directed to a device for enabling an aircraft maintenance operator to safely access the exterior body of an aircraft (also known as fuselage) for periodical maintenance purposes thereof and the like. Referring to FIGS. 1 through 5, the device 10 comprises a substantially frame structure, which is adapted to be firmly anchored to the fuselage 12. The device 10 comprises a pair of vertical legs 14 and an elongate horizontal platform 16 extending between top extremities of the pair of vertical legs 14 whereby, the platform 16 acts as a bridge between the pair of legs 14. While the pair of legs 14 straddles the sides of the fuselage 12 when the device 10, as mentioned earlier, is anchored to the fuselage 12, the platform 16 is disposed above and across the fuselage 12 with respect to the longitudinal axis thereof.

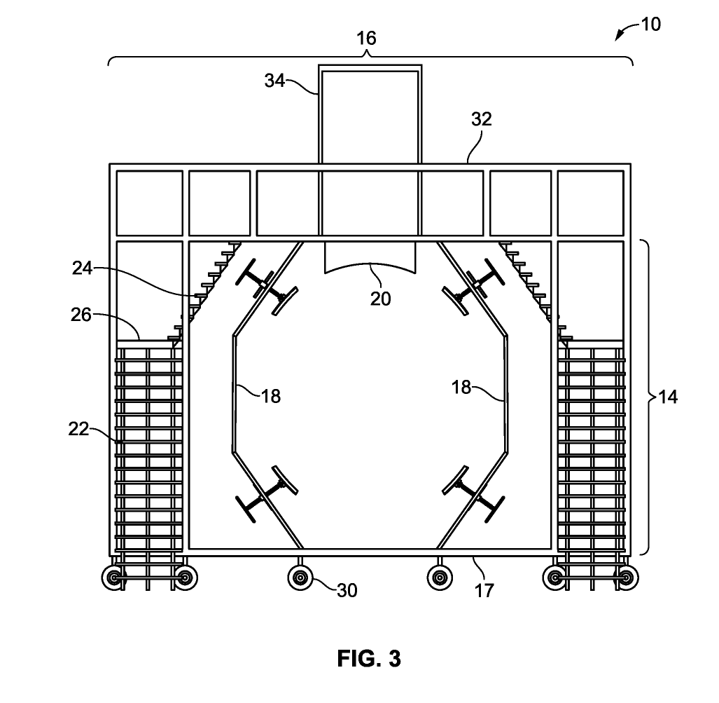

Referring to FIGS. 1 through 5, each leg 14 is a tall rectangular frame structure comprising a means for leading an operator from the ground to the platform 16 therethrough. The leading means comprises two staircases, viz., bottom and top staircases 22 and 24. Notably, the direction of ascent (or descent) of the top and bottom staircases 22 and 24 is perpendicular to each other. As can be appreciated from FIG. 3, as viewed from front, the bottom staircases 22 are parallel to each other, while the top staircases 24, with respect to the direction of the ascent thereof, are slanted inwardly. Each leg 14 further comprises a landing area 26 connecting the bottom and top staircases 22 and 24. Notably, as the bottom staircase 22 is longer than the top staircase 24, the landing area 26 is disposed above midway of the leg 14. Therefore, simply put, the bottom staircase 22 leads to the landing area 26 and the top staircase 24, which proceeds from the landing area 26, leads to the platform 16.

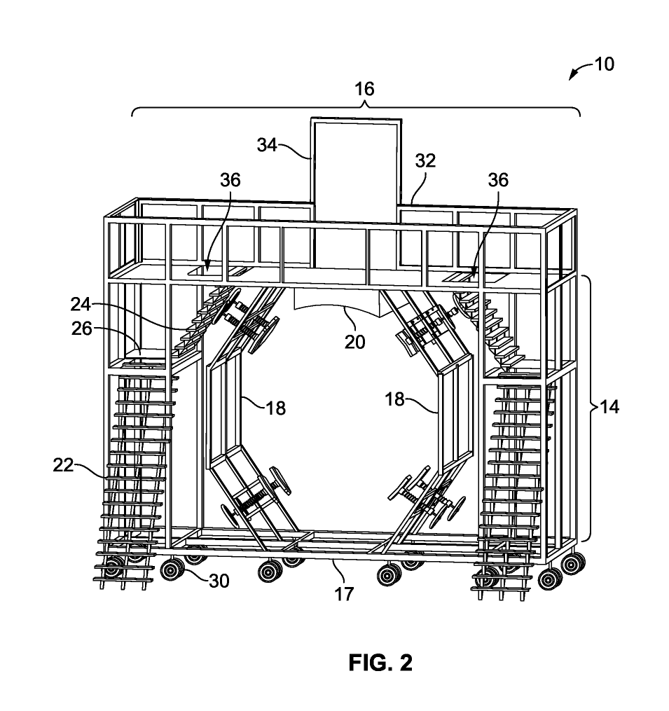

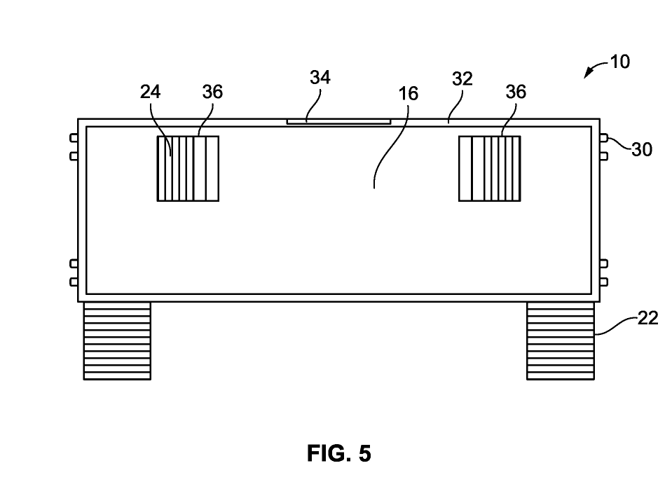

Referring to FIGS. 2 and 5, two preferably rectangular openings 36 are disposed on the platform 16 wherein, each opening 36 is connected to a top staircase 24. Notably, as viewed from top, the direction of the ascent of the top staircase 24 aligns with or is parallel to the longitudinal axis of the platform 16. Each opening 36 is intended to lead the operator therethrough onto the platform 16 from the top staircase 24. In one embodiment, each opening 36 is hingedly secured with a correspondingly matching rectangular trapdoor (not shown) to one of the edges thereof. The trapdoor, when closed over its corresponding opening 36, is adapted to become flush with the surface of the platform 16. The trapdoor prevents a potential injury as it prevents an operator from accidentally falling through the opening 36.

Referring to FIGS. 1 through 5, a step assembly 20 comprising a plurality of steps leads the operator from the platform 16 onto the top of the fuselage 12. As can be appreciated from FIG. 1, the contour of the bottom of the step assembly 20 matches with that of the fuselage 12 so as to achieve a geometrical fit therebetween. A rectangular doorframe 34, which is a part of the platform 16, is erected whereby, the operator passes therethrough before assessing the step assembly 20. The doorframe 34 is defined by a pair of vertical bars joined at the top extremities thereof by a horizontal bar. The utility of the doorframe 34 will become apparent from the following body of text. The platform 16 further comprises a railing 32 provided on all sides thereof. The surface of the steps pertaining to the top and bottom staircases 24 and 22, the steps pertaining to the step assembly 20 and the surface of the platform 16 comprises a non-slip surface. In one embodiment, said surfaces are additionally textured so as to provide better grip to the operator. This is especially advantageous when the aircraft is parked outside of a hangar, where it is exposed to natural elements such as, mist, rain, etc., which likely causes slippage on the platform 16 or on said steps.

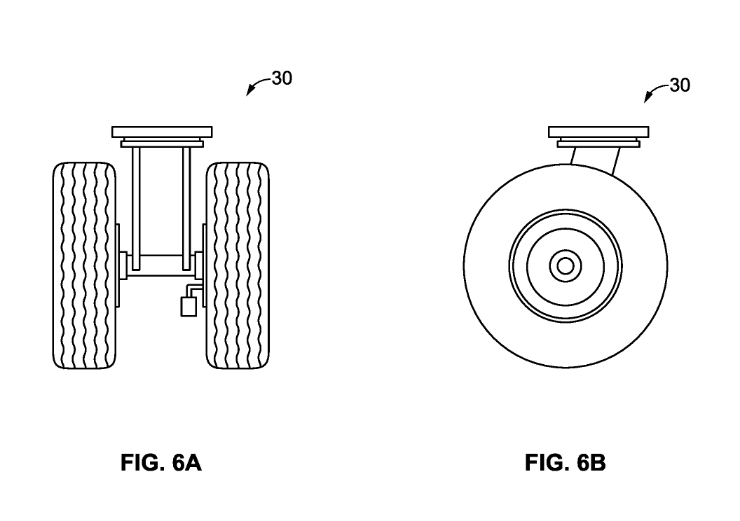

Referring to FIGS. 1 through 6B, the device 10 further comprises a horizontal, rectangular bottom frame 17 extending between the legs 14 closer to the bottom extremities thereof. The bottom frame 17, which is a simple arrangement of three parallel longer bars (parallel to the platform 16) integrated with two intersecting perpendicular shorter bars, is located directly beneath the platform 16 and is adapted to go beneath the fuselage 12. The bottom of the legs 14 and the bottom frame 17 are fitted with a plurality of dual caster wheels 30, which are adapted to carry more than the weight of the device 10. More particularly, the bottom each leg 14 is fitted with four dual caster wheels 30 at the four corner thereof, while the bottom of the bottom frame 17 is fitted with another four caster wheels 30. The dual caster wheels 30 are instrumental in adjusting the device 10, while the device 10 is being anchored to the fuselage 12.

Referring to FIGS. 1 through 4, an anchoring means is employed for anchoring the device 10 to the fuselage 12. The anchoring means comprises a pair of opposingly-disposed anchor assemblies 18 extending between the platform 16 and the bottom frame 17 wherein, each anchor assembly 18 is configured to engage a side of the fuselage 12. Notably, each anchor assembly 18 is disposed between a side of the fuselage 12 and the leg 14 that is proximal thereto.

Referring to FIGS. 1 through 4 and 7, the anchor assembly 18 comprises top and bottom oblique, rectangular anchor frames 38T and 38B wherein, each of the top and bottom frames 38T and 38B comprises three oblique, parallel bars that are joined at the extremities thereof by a horizontal bar. Further, each of the top and bottom anchor frames 38T and 38B comprises a solid, centrally-disposed anchor plate 39. Notably, the anchor plates 39 that are part of the top and bottom anchor frames 38T and 38B are referred to as top and bottom anchor plates 39. The anchor plate 39 comprises at least one and preferably two threaded holes, the utility of which will become apparent from the following body of text. While the top anchor frame 38T extends obliquely downwardly from the bottom of the platform 16, the bottom anchor frame 38B extends obliquely upwardly from the top of the bottom frame 17. The anchor assembly 18 further comprises a mid frame 40 simply consisting of three vertical bars. The free bottom and top extremities of the top and bottom anchor frames 38T and 38B are connected by the mid frame 40 such that, the tree oblique bars of the top and bottom anchor frames 38T and 38B align with the three vertical bars of the mid frame 40, altogether forming a substantially concave structure with respect to the side of the fuselage 12. Notably, the location of the four caster wheels 30 attached to the bottom frame 17 aligns with the line of contact of the bottom anchor frame 38B on the bottom frame 17.

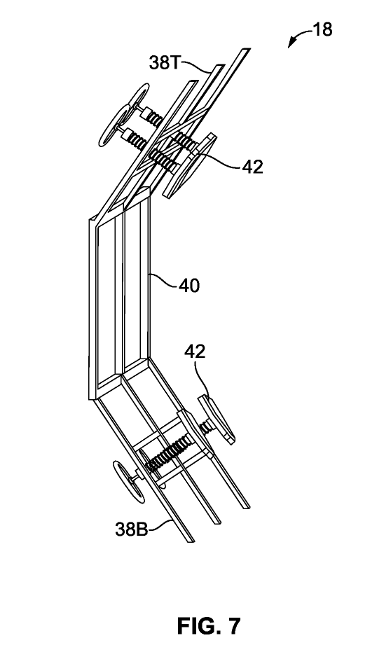

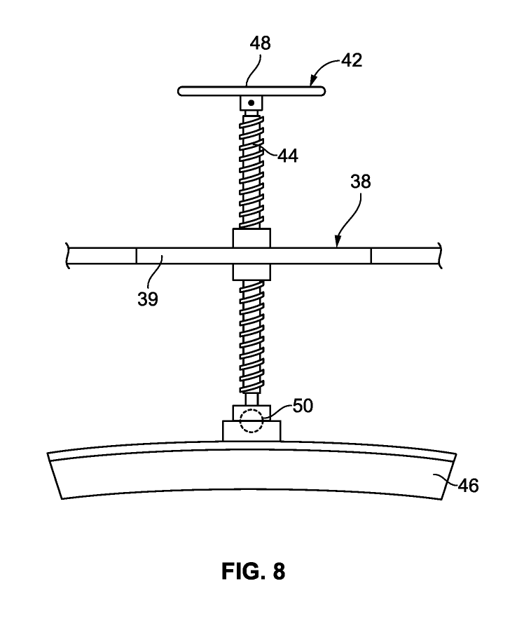

Referring to FIGS. 7 and 8, the anchor assembly 18 further comprises a plurality of jackscrews 42, each of which is adapted to be threadably received within a threaded hole. More particularly, four jackscrews 42 are employed by an anchor assembly 18. Each jackscrew 42 comprises a threaded rod 44, the proximal and distal extremities of which are operationally attached with a drive wheel 48 and a pressure pad 46. As the threaded rod 44 is threadably received within the threaded hole, the rotation of the drive wheel 48 causes the threaded rod 44 to be threadably advanced or retracted via the threaded hole. More particularly, the rotation of the drive wheel 48 in clockwise direction advances the threaded rod 44 forward and the rotation of the drive wheel 48 in counter-clockwise direction retracts the threaded rod 44 backward. The pressure pad 46 is secured to threaded rod 44 by means of a ball-and-socket joint 50.

Referring to FIGS. 1 and 8, by virtue of the rotation of the drive wheel 48, the pressure pad 46 is intended to firmly engage the surface of fuselage 12 by means of sheer pressure. Notably, the contour of the pressure pad 46 matches that of the side of the fuselage 12 so as to achieve a proper fit therebetween. The ball-and-socket joint 50 is also instrumental in ensuring a proper engagement between the pressure pad 46 and the side of the fuselage 12. Once all the jackscrews 42 (on both the anchor assemblies 18) are engaged to the fuselage 12 in the aforementioned fashion, the device 10 is rendered anchored to the fuselage 12.

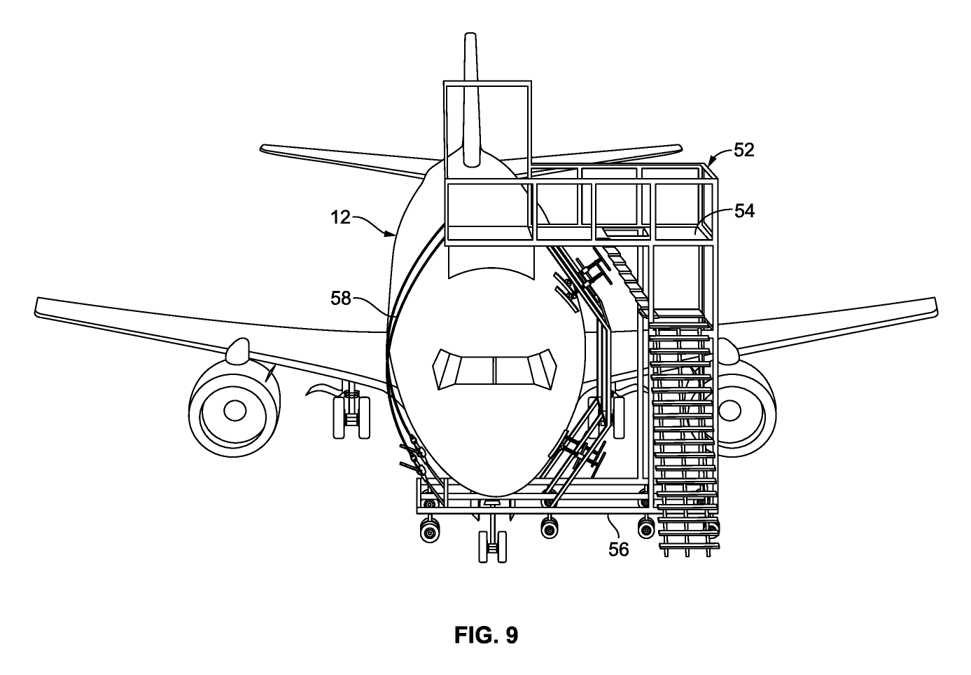

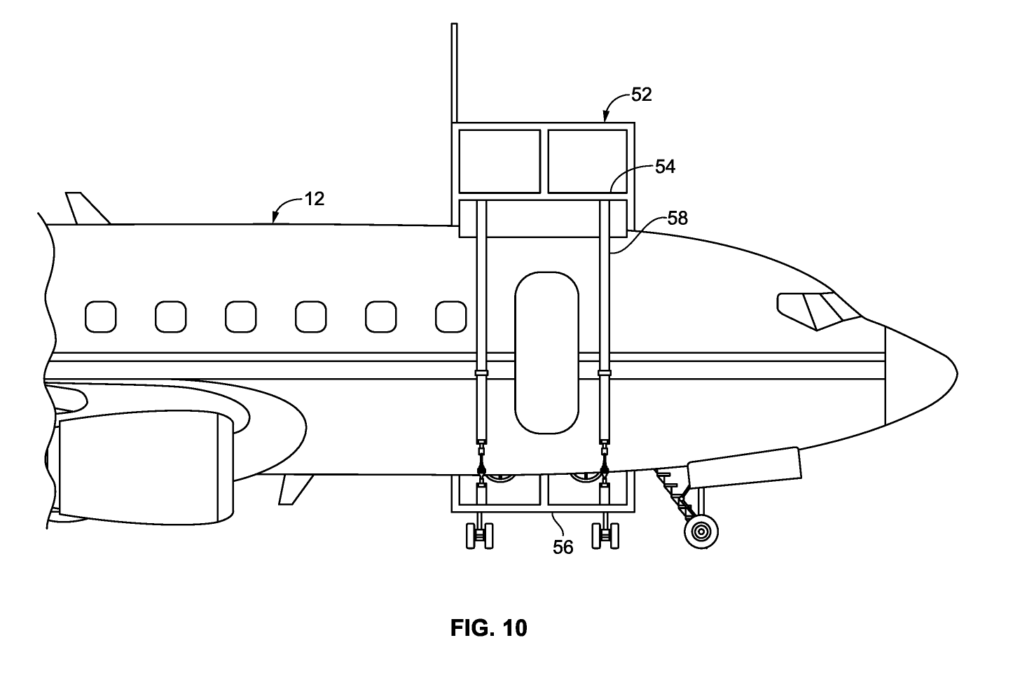

Referring to FIGS. 9 and 10, in one embodiment, the device 10, about a vertical axis, is adapted to be detachable into two sections resulting in viz., a usable section 52 and a non-usable section. The two sections are adapted to be attachable by means of connectors and pins. The usable section 52 includes a leg 14, a segment of the platform 54 (hereinafter referred to as usable platform segment 54) and a segment of the bottom frame 56 (hereinafter referred to as usable platform segment 56). Notably, the length of the usable platform segment 54 and the usable bottom frame segment 56 is greater than that of the non-usable platform segment (i.e., part of the platform 16 pertaining to the non-usable section) and the non-usable bottom frame segment (i.e., part of the bottom frame 17 pertaining to the non-usable section). More particularly, as can be appreciated from the referred illustrations, the usable platform segment 54 includes the doorframe 34 and the step assembly 20 and the usable bottom frame section 56 extends beyond the other side of the fuselage 12.

Referring to FIGS. 9 and 10, in order to anchor the usable section 52 to the fuselage 12, a pair of straps 58, each of which extending between the free extremities of the usable platform segment 54 and usable bottom frame segment 56, is employed. In order to anchor the usable section 52 to the fuselage 12, the anchor assembly 18 of the usable section 52 is engaged to one side of the fuselage 12 in the aforementioned fashion. Almost simultaneously, the straps 58 are tightened by means of a ratchet wrench whereby, the length thereof is reduced, which ultimately leads to the usable section 52 being anchored to the fuselage 12.

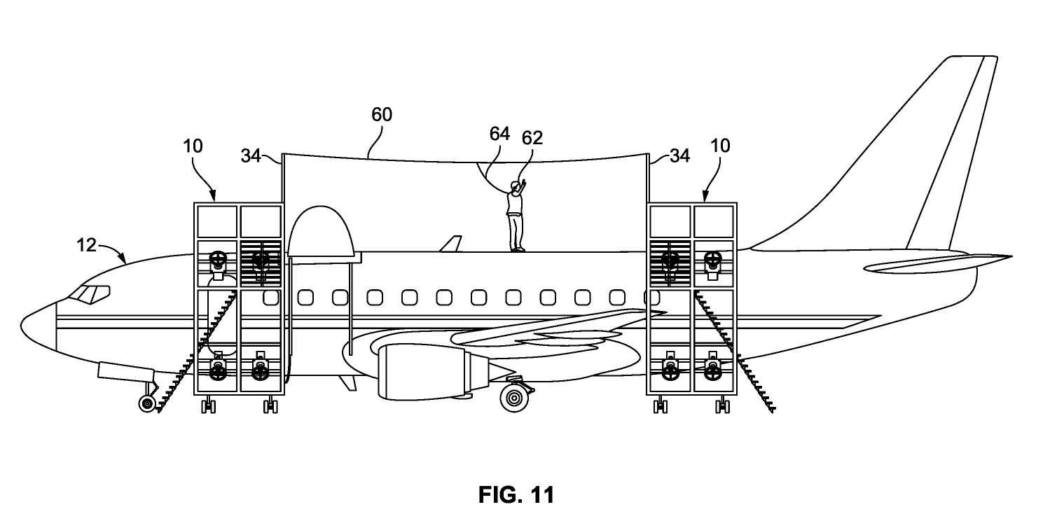

Referring to FIG. 11, in one embodiment, two devices 10 are anchored to the fuselage 12—one at the front and the other at the rear. In this embodiment, a cable 60 is connected between the top horizontal bars of the doorframes 34. The operator 62 is tethered to the cable 60 by means of a harness 64, which prevents the operator 62 from falling from the top of the fuselage 12 and potentially injuring himself/herself. Similar arrangement can also be made using two usable sections 52 in lieu of the devices 10.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A device for enabling an aircraft maintenance operator to access the exterior body of the aircraft, the device releasingly anchored to the fuselage of the aircraft, the device comprising:
(a) a platform disposed above and transversely with respect to the fuselage; and
(b) a pair of legs straddling the fuselage, the platform extending between the pair of legs, each leg comprising a leading means for leading the operator to reach the platform from the ground therethrough.

2. The device of claim 1 supported by a plurality of swiveling dual caster wheels at the bottom thereof.

3. The device of claim 1 wherein, each leg is supported by a plurality of dual caster wheels disposed at the bottom thereof.

4. The device of claim 1 wherein, the leading means comprises at least one staircase extending through the leg.

5. The device of claim 7 wherein, the at least one staircase comprises two staircases viz., a bottom and a top staircase; the bottom staircase leading to a landing area and the top staircase, the stairs of which are perpendicular to that of the bottom staircase, leading to the platform from the landing area through an opening disposed on the platform.

6. The device of claim 8 wherein, the platform further comprises a trapdoor for removably covering the opening, the trapdoor being flush with the surface of the platform when covered over the opening.

7. The device of claim 1 adapted to be detachable into usable and non-usable sections, the usable section, by itself, adapted to fulfill the function of the device, which is to enable the operator to access the exterior body of the aircraft, each of the usable and non-usable sections comprises a leg and a platform segment, the platform segment pertaining to the usable and non-usable sections referred to as usable and non-usable platform segments respectively; the length of the usable platform segment being more than that of the non-usable platform segment.

8. The device of claim 7 further comprising a step assembly comprising a plurality of steps extending between the platform and the fuselage, the step assembly being disposed centrally with respect to the longitudinal axis of the platform.

9. The device of claim 8 wherein, the step assembly is a part of the usable section.

10. The device of claim 7 wherein, the platform comprises a doorframe through which the operator accesses the plurality of steps from the platform, the doorframe being disposed centrally with respect to the longitudinal axis of the platform.

11. The device of claim 10 wherein, the doorframe is a part of the usable section.

12. The device of claim 10 wherein, the platform comprises a railing disposed on all sides thereof; the railing not to interfere with the doorframe.

13. The device of claim 7 further comprising a horizontal bottom frame extending between the legs, the bottom frame disposed below the fuselage whereby the fuselage is surrounded by the device on all sides thereof; the bottom frame supported by a plurality of caster wheels disposed at the bottom thereof.

14. The device of claim 13 further comprising an anchoring means for anchoring the device to the fuselage, the anchoring means comprising a pair of anchor assemblies disposed on either side of the fuselage, each anchor assembly comprising:
(a) a top anchor plate extending obliquely downwardly from the bottom of the platform, the top plate comprising at least one threaded hole;
(b) a bottom anchor plate extending obliquely upwardly from the top of the bottom frame, the bottom plate comprising at least one threaded hole;
(c) a vertical mid frame connecting top and bottom plates whereby, the top and bottom plates and the mid frame form a substantially concave structure with respect to the side of the fuselage; and
(d) jackscrews, each of which comprising:
(a) a threaded rod adapted to be threadably longitudinally reciprocated with a threaded hole;
(b) a drive wheel disposed at the proximal extremity of the threaded rod, the rotation of the drive wheel enabling an operator to thread the threaded rod to and from through the threaded hole; and
(c) a pressure pad disposed at the distal extremity of the threaded rod, the pressure pad, as driven by the drive wheel, adapted to contact the fuselage in order to pressure thereon, the contour of the pressure pad matching with that of the fuselage;
wherein, when all the jackscrews exert sufficient pressure on the fuselage by means of the respective pressure pads as enabled by the rotation of the drive wheel, the device is rendered anchored to the fuselage

15. The device of claim 14 wherein, the at least one threaded hole disposed on each of the top and bottom plates comprises two threaded holes.

16. The device of claim 14 wherein, the usable and non-usable sections comprise a segment of the bottom frame each; the bottom frame segment pertaining to the usable and non-usable sections referred to as usable and non-usable bottom frame segments respectively, the length of the usable bottom frame segment is greater than that of the non-usable bottom frame segment such that, the free extremity of the bottom frame segment extends beyond the fuselage

17. The device of claim 16 wherein, in the event of the usable section is employed alone, the anchoring means comprises the anchor assembly pertaining to the usable section and at least one strap extending between free extremities of the usable platform segment and the usable bottom frame segment while abutting the side of the fuselage that is opposite to that of the usable section; the length of the at least one strap adapted to be tightened or loosened wherein, the tightening of the strap in combination with the tightening of the jackscrews enable the anchoring of the usable section to the fuselage.

18. The device of claim 17 wherein, the at least one straps comprises a pair of parallel straps.

19. A device for enabling an aircraft maintenance operator to access the exterior body of the aircraft, the device releasingly anchored to the fuselage of the aircraft, the device comprising:
(a) a platform disposed above and transversely with respect to the fuselage; and
(b) a pair of legs straddling the fuselage, the platform extending between the pair of legs, each leg comprising a bottom and a top staircase, the bottom staircase leading to a landing area and the top staircase, the stairs of which are perpendicular to that of the bottom staircase, leading to the platform from the landing area through an opening disposed on the platform;
the device adapted to be detachable into usable and non-usable sections, the usable section, by itself, adapted to fulfill the function of the device, each of the usable and non-usable sections comprises a leg and a platform segment, the platform segment pertaining to the usable and non-usable sections referred to as usable and non-usable platform segments respectively; the length of the usable platform segment being more than that of the non-usable platform segment, the usable section adapted to be anchored to the fuselage by employing at least one strap in lieu of the non-usable section.
